(19) United States
(12) Patent Application Publication
(10) Pub. No.: US 2022/0120474 A1
(43) Pub. Date: Apr. 21, 2022

(54) METHOD AND SYSTEM FOR CONTROLLING THE OPERATION OF A CSP RECEIVER

(71) Applicant: Vast Solar Pty Ltd, Darlinghurst, New South Wales (AU)

(72) Inventors: Allan CURTIS, Darlinghurst (AU); Kurt Friedrich DREWES, Darlinghurst (AU); Nicole Ann BLINCO, Darlinghurst (AU)

(21) Appl. No.: 17/436,556

(22) PCT Filed: Mar. 3, 2020
(86) PCT No.: PCT/AU2020/050194

§ 371 Date: Sep. 3, 2021

(30) Foreign Application Priority Data
Mar. 6, 2019 (AU) 2019900731

(51) Int. Cl. F24S 50/40; F24S 10/70; F24S 20/20; F24S 23/77; F24S 80/20

(52) U.S. Cl. CPC F24S 50/40; F24S 10/70; F24S 80/20; F24S 23/77; F24S 20/20

(57) ABSTRACT

A concentrated solar energy collection system includes an array of heliostats and a solar receiver that further includes a plurality of tubes having at least one inlet and at least one outlet for carrying a heat transfer fluid (HTF). A flow control arrangement is provided for controlling the flow of HTF through the tubes. This includes at least one radiation sensor such as a pyranometer for sensing values representative of the aggregate solar radiation falling on the solar receiver via the heliostats. At least one temperature sensor measures input temperature of the HTF at or near the inlet. A controller coupled to the radiation and temperature sensors regulates the outlet temperature of the HTF by controlling the flow of HTF through the tubes via the flow control arrangement. A pressure differential sensor arrangement measures pressure differential across the flow control arrangement, providing an input to the controller.

### FIELD OF THE INVENTION

The present disclosure relates to a method and system for controlling the operation of a CSP (concentrated solar power) receiver, as well as to a CSP installation incorporating such a system.

### BACKGROUND OF THE INVENTION

In one form of tower-based CSP, the use of the sun's reflections as a heat source is applied to heating a heat transfer fluid (HTF) by focusing the sun onto a tower-based receiver using an array of sun-tracking heliostat mirrors. The HTF is passed through the receiver and heated to a target outlet temperature. It is desirable to minimise variations in the outlet temperature, both for improved process control of the power block, and to reduce stress variations and improve life for those mechanical and structural components affected by the HTF temperature.

As the heat input from a CSP plant relies on focusing the sun on the receiver, it can vary almost instantly from full to zero power. This can occur either involuntarily, with the passage of clouds and other atmospheric disturbances blocking the sun, or voluntarily, with the heliostats diverting the images of the sun away from the receiver.

One process control variable for controlling the output temperature from the receiver is the flow rate of the HTF through the receiver, which is typically adjusted by setting a position on a flow control valve arrangement. The combination of very rapid changes in heat input, both voluntary and involuntary, with a requirement for a stable output temperature makes the control of flow rate to regulate output temperature fundamentally difficult. The heat input can typically vary between full and zero power in much less than the time required for HTF to pass through the receiver.

Closed loop control of the flow rate using feedback from the outlet temperature is relatively unstable as the effect of receiver heat input variations on outlet temperature has a significant time delay, and results in significant undesirable outlet temperature over- and under-shoots. Closed loop control can be improved by using thermal imagery to measure the temperatures across the receiver, however while this reduces the time delay in the feedback, the control remains relatively unstable.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect there is provided a concentrated solar energy collection system including: an array of heliostats; a solar receiver including a plurality of tubes having at least one inlet and at least one outlet for carrying a heat transfer fluid, an external surface of the tubes receiving solar radiation reflected from the array of heliostats for heating the heat transfer fluid; a flow control arrangement for controlling the flow of heat transfer fluid through the tubes; at least one radiation sensor for sensing values representative of the aggregate solar radiation falling on the solar receiver via the heliostats; at least one temperature sensor for measuring input temperature of the HTF at or near the inlet; a controller responsive to the at least one radiation sensor and the at least one temperature sensor for regulating the outlet temperature of the heat transfer fluid by controlling the flow of heat transfer fluid through the tubes via the flow control arrangement.

The concentrated solar energy collection system may include a pressure differential sensor arrangement for measuring pressure differential across the flow control arrangement, the pressure differential sensor arrangement providing an input to the controller. The at least one radiation sensor may include an actinometer spaced from the receiver and having a window configured to mask radiation not emanating from the receiver.

The actinometer may include a pyranometer, such as a thermopile pyranometer.

The flow control arrangement may be in the form of a valve arrangement including a split valve arrangement having a turn down ratio of at least 10:1, at least 12:1 or about 15:1.

During normal operation the outlet temperature of the HTF is typically solely controlled by the valve arrangement.

The HTF may be a liquid metal, either as a pure element or in a eutectic mixture with other elements, the HTF being selected from a group comprising liquid sodium, eutectic mixtures of sodium and potassium (NaK), eutectic mixtures of lead and bismuth (PbBi), and tin.

The concentrated solar energy collection system may include a flow sensor for measuring the inflow of HTF into the receiver, the flow sensor providing an input to the controller.

The concentrated solar energy collection system may include at least one thermal imaging camera or sensor for providing data associated with a thermal image of an outer face of the receiver to the controller.

There is further provided a concentrated solar energy installation comprising a plurality of solar energy collection systems of the type described above, an HTF reservoir, a pump for recirculating HTF through the systems, and a heat exchanger for extracting heat from the HTF using a second HTF which is preferably salt, wherein the salt is used as a heat source to drive one or more steam turbines.

There is still further provided a method of operating a concentrated solar energy collection system including: an array of heliostats; a solar receiver including a plurality of tubes having at least one inlet and at least one outlet for carrying a heat transfer fluid, an external surface of the tubes receiving solar radiation reflected from the heliostats for heating the heat transfer fluid; and a flow control arrangement for controlling the flow of heat transfer fluid through the tubes; the method including: sensing values representative of the aggregate solar radiation falling on the solar receiver via the heliostats using at least one radiation sensor; measuring the input temperature of the HTF at or near the inlet using at least one temperature sensor; and responsive to the radiation sensor and input temperature, regulating the outlet temperature of the heat transfer fluid by controlling the flow of heat transfer fluid through the tubes via the flow control arrangement.

It will be appreciated that the disclosure is not only directed towards the system or installation as a whole but also includes individual modules or components or synergistic groups of such modules or components. By way of non-limiting example this would include the controller, the controller with inputs and outputs including the various sensors providing inputs and the valve arrangement providing the controllable output, in particular for carrying out the above method. The group of components or modules may further include the receiver, in a particular with one or more of the features described and claimed in co-pending published PCT application PCT/AU2018/051220, also in the name of the applicant.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 shows a highly schematic view of CSP installation;

FIG. 2 shows a schematic view of a first embodiment of a receiver control system according to the present disclosure;

FIG. 3 shows a second embodiment of a receiver control system according to the present disclosure;

FIG. 4 shows a third embodiment of a receiver control system according to the present disclosure;

FIG. 5 shows a fourth embodiment of a receiver control system according to the present disclosure;

FIG. 6 shows a fifth embodiment of a receiver control system according to the present disclosure;

FIG. 7 shows a partly schematic perspective view of a pyranometer assembly mounted in a position on a solar tower;

FIG. 8 shows a perspective cut-away detail of the pyranometer assembly of FIG. 7; and

FIG. 9 shows a graph of output temperature of liquid sodium over time in response to variations in DNI and flow rate of sodium through the receiver.

### DETAILED DESCRIPTION OF THE EMBODIMENTS

Control stability can be improved by using measurements of solar radiation incident on the solar field as inputs to the control system. The solar radiation measurements may be included either through modelling or empirical measurement of the effect of the solar radiation on HTF temperature to implement feed forward control loops or other non-linear predictive controls. Solar radiation measurement can thus be used to forecast the future outlet temperature for different control valve settings. In order to accurately measure solar radiation on the field many solar radiation or flux detectors would need to be mounted throughout the solar field. This could be done on each heliostat or on/centered on small clusters of heliostats. This is resource intensive as well as not always being representative of the radiation falling on the receiver when all the heliostat mirrors are not focussed on the receiver precisely or at all.

A further HTF control complication relates to the achievable turn down ratio for the flow control valve used to control the flow of the HTF through the receiver. The turn down ratio is the maximum flow rate divided by the minimum flow rate achievable with the flow control valve and its associated control elements In this regard it will be appreciated that the maximum flow rate is relevant for the maximum heat input, while the minimum flow rate desired for the system is a function of the minimum heat input for which operation is required.

Typically, CSP plants achieve turn down ratios of around 5:1 or less, using valves and control methods adopted from traditional heating systems. While the flow control valve and associated control elements may have good adjustability near the maximum flow rate, and allow reasonable control near maximum heat input, the adjustability is poor near the minimum flow rate. In traditional heating systems, such as with furnace driven heaters, the thermal mass of the heater and the consistent combustion rates provide significant inertia that makes the need for good adjustability near minimum flow rates less important.

However, with CSP systems, the variability of heat input at lower heat levels (morning and evening, winter, light cloud) remains almost instantaneous, and the requirements for adjustability and associated controllability are more difficult, in particular when using the above conventional flow control valve and control elements. In the case of variable low radiation, one common approach has been simply to deactivate the system by closing the valve and defocussing the heliostats. It will be appreciated that this approach does not represent the best usage of the available radiation.

A final further complication for CSP heating occurs where the receiver does not contain explicit receiver sections limited to a single controlled flow rate. For example, some central tower receivers have a footer manifold at the base of the tower heating element, and a header manifold at the top, with the two headers connected by a series of closely spaced vertical tubes. Where the flow rate for the whole receiver is controlled via a single flow control, it can be appreciated that the instantaneous heat input on different parts of the receiver may be quite different, resulting in significant variations in temperature for the vertical pipes spread around the receiver.

An improvement in control can be achieved if a section of receiver can be isolated such that all the HTF that flows through that section of receiver and only that section of receiver can be controlled by a flow control device, and the aggregated solar radiation on only that section of receiver can be measured directly using an actinometer such as a pyranometer, or more specifically a thermopile pyranometer or other sensor measuring the heat incident on the section of receiver. In this case, provided the inlet temperature or a proxy for it is known, a feed forward controller can be implemented to use the aggregated solar input to calculate the heat input to the receiver, and predict the future outlet temperature as a function of the flow control device setting. The requirements for this control implementation are knowledge of the inlet temperature or proxy for it, desired outlet temperature, measurement of the aggregate solar radiation on the element of the receiver, setting of a flow control device, and a model, empirical or otherwise, that provides feed forward calculation of the desired flow control device setting at any instant in time as a function of the inlet temperature and aggregate solar radiation.

There are several steps that can be used to further improve the controllability of the system, including explicitly measuring the outlet temperature and flow rate. These measurements confirm that the setting of the flow control device has achieved the desired flow rate, and that the feed forward control strategy has achieved the desired outlet temperature.

Further improvements in control can also be achieved using one or more thermal cameras providing thermal imagery of the temperatures across the receiver as inputs to the controller to improve the accuracy of the model controlling the flow control device or valve arrangement.

The flow control device can be modified to provide a significant increase in turn down ratio, thereby improving adjustability and therefore controllability for the system at lower heat inputs. This may be achieved by an improved flow control valve and associated control elements with finer control capabilities, or by a parallel array of flow control valves that can be operated selectively to improve adjustability at low flow rates. In the case of parallel or split valves it will be appreciated that the individual valves may have turn down ratios of 5:1 or even less, with their turn down ratio in combination being a product of the individual turn down ratios. By way of example if two valves with turn down ratios of 5:1 were deployed in parallel, the maximum flow rate would be twice the maximum flow rate for each valve in isolation, and the turn down ratio for the combination would be of the order of 10:1. Split valve arrangements with high and low flow valves in parallel may also be used, in which case the net turn down ratio may be a product of the individual turn down ratios for each valve. Turn down ratios of up to 20:1 may be achieved using split valve arrangements or an individual valve with finer control capabilities as described above.

Having high turn down ratios in the flow control device, along with the measurement of aggregate solar radiation, may improve the ability to maintain constant outlet temperatures at lower incident radiation, in particular where the radiation is highly variable.

It will be appreciated that having the receiver elements for a solar field provided as multiple discrete receiver elements allows for easier measurement of the aggregate solar radiation on each discrete receiver element, and this control technique is therefore particularly suited to the control of multiple discrete receiver elements.

It can be further appreciated that the use of cavity-style billboard receivers as the receiver elements will likely improve the accuracy of the aggregate solar radiation measurement, as this configuration facilitates the measurement of aggregate radiation.

Use of high conductivity heat transfer fluids, such as liquid metals, including liquid sodium, eutectic mixtures of sodium and potassium (NaK), eutectic mixtures of lead and bismuth (PbBi), and tin, allows the use of more compact receivers, improves the measurability of the aggregate solar radiation and reduces the control time constants by reducing the time required for the HTF to pass through the receiver element to get heated to the desired temperature. The use of such high conductivity HTF's is therefore well suited to this control technique.

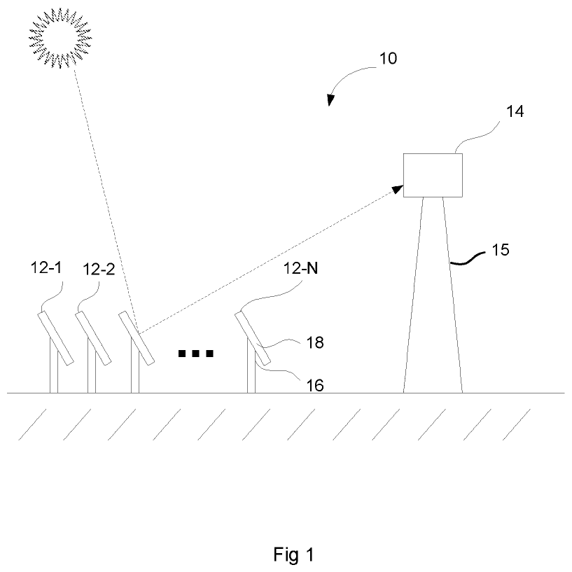

Various embodiments of the disclosure will now be described in more detail with reference to the accompanying figures. Referring first to FIG. 1, a CSP system 10 includes an array of heliostats 12-1, 12-2, 12-N (collectively an array 12) for reflecting sunlight towards a solar thermal receiver module 14 on a tower 15. In its simplest form, each heliostat includes a support member 16 and a reflecting member 18 supported by the support member 16. The support member 16 is secured to the ground and is thus intended to be stationary, whereas the reflecting member 18 is adjustably or controllably rotatable about at least two axes (typically azimuth and elevation, but others may also be used) relative to the support member 16. The relative rotation is desired in two scenarios. The first scenario is to compensate for the sun's apparent movement during daytime to facilitate continuous solar power being directed towards the solar power receiver module 14. The second is to calibrate the heliostat orientation.

The solar thermal receiver module may be in the form of the solar thermal receiver described and illustrated in the complete specification of published PCT application PCT/AU2018/051220, the contents of which are incorporated herein by reference in their entirety.

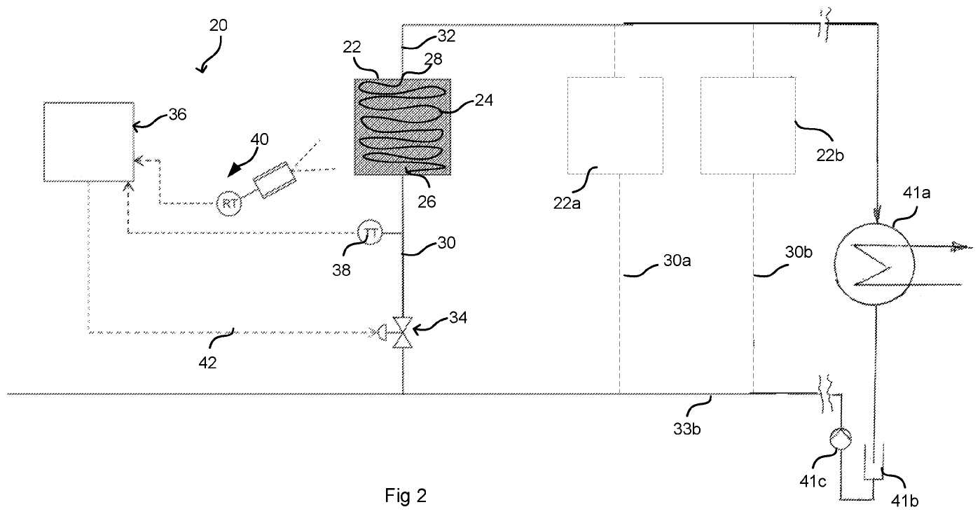

Referring now to FIG. 2, a receiver control system 20 is shown including CSP receiver 22 of the type described and illustrated in the above PCT publication, including a serpentine array of tubes 24 having a lower inlet manifold 26 and an upper outlet manifold 28 fed and drained by respective inlet and outlet pipes 30 and 32. In the case of multiple tubes extending from the inlet to the outlet manifold as taught in the above PCT publication, the length of each of the tubes is similar or identical so that the transition time of HTF though each tube is substantially the same, resulting in similar heating profiles for each of the tubes. In the present embodiment, the heat transfer fluid conveyed through the pipes and serpentine array of tubes is liquid sodium. The flow of sodium is regulated or controlled by a valve arrangement 34 located in the inlet pipe 30. The operation of the valve arrangement 34 is in turn controlled by a central controller 36. The central controller 36 is designed to regulate the outlet temperature of the sodium exiting the outlet pipe 32 so that it stays constant and within a target temperature. In the case of sodium, this target temperature is typically in the region of 550 C-650 C. The broad temperature range at which sodium remains a liquid (98 C to 883 C), provides a sufficient ceiling above operating temperatures in the range of 550 C-650 C in the event of overheating, as well as a lower temperature of solidification, in comparison with molten salt, which has traditionally been used.

Inputs to the controller 36 include a temperature sensor 38 for sensing the temperature of the liquid sodium in the region of the inlet and a flux or radiation sensor 40. The radiation sensor 40 is configured to measure the aggregate flux or radiation across the receiver 22 on a continuous basis and to convey this measurement to the controller 36. It will be appreciated that when referring to aggregate radiation this does not refer to all the solar radiation falling on the receiver. The sensor is rather configured to sense a value in W/m² representative of the solar radiation falling on the receiver by measuring for example a combination of radiation reflected from the receiver and black body radiation emitted by the surface of the receiver.

The radiation sensor may be an actinometer or pyranometer. This may take the form of a thermopile pyranometer, such as the SP-510 upward-looking sensor manufactured by Apogee Instruments, Inc, of 721 W St 1800 N St, Logan, Utah. The pyranometer will be described in more detail further in the specification.

According to one or more embodiments, the controller 36 can be centralized in a single computer or distributed among several processors or PLC's. For example, a central controller system can communicate hierarchically through a data communications network. This could include with controllers of individual heliostats, together with the temperature controller 36. The entire data communications network can be without hierarchy, for example in a distributed processing arrangement using a peer-to-peer communications protocol.

The controller 36 communicates with the valves and sensors using standard industrial analogue or digital hardwired or wireless communications. The controller comprises combinations of classical PID control loops, as well as non-linear control components with feedback and feed forward, loops, as required.

By measuring a value representative of the aggregate radiation falling on the receiver from the array of heliostats, this measurement may be input to the controller 36, and acts as a predictor of the outlet temperature of the molten sodium prior to the outlet temperature responding to the measured increase or decrease of radiation on the receiver. In the embodiment of FIG. 2, the valve arrangement 34 controls the flow of liquid sodium through the entire receiver 22. The outlet pipe 32 feeds into a main outlet line 33a which conveys heated liquid sodium from the receiver 22 as well as from additional receivers 22a and 22b back to a central heat exchanger 41a at which the liquid sodium is used to heat an intermediate heat transfer fluid such as molten salt, which is in turn used to convert water to superheated steam which drives one or more steam turbines. The molten sodium may also be used to heat the water directly, subject to appropriate safety measures. The cooled molten sodium is fed back to the input pipes 30, 30a and 30b via storage tank 41b, pump 41c and return line 33b.

In one example, a passing cloud will temporarily obscure or at least attenuate radiation from at least some of the heliostats in the array. As the cloud moves, the radiation profile will fluctuate as heliostats in the array are successively obscured or revealed. This in turn has an impact on the aggregate radiation on the receiver 22, which fluctuation is then sensed by the radiation sensor 40. The feed forward controller 36 generates a control signal based on the input from the radiation sensor 40 and the inlet fluid temperature sensor 38 which is in turn transmitted to the control valve 34, as shown at 42 to increase or decrease the flow rate of liquid sodium through the tubes 24 of the receiver 22.

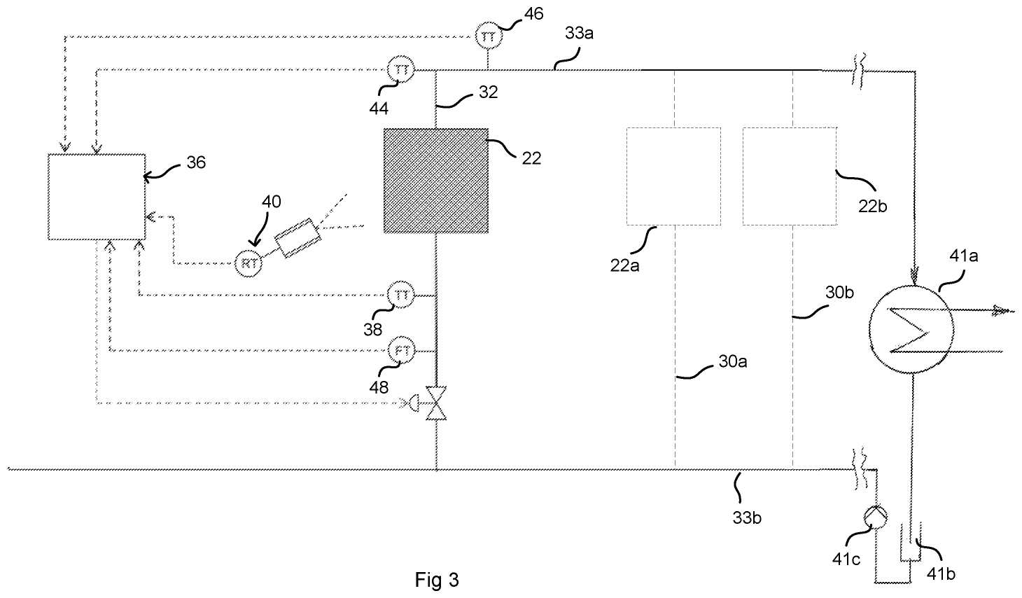

In FIG. 3, a third embodiment of a receiver control system is shown in which additional temperature sensors 44, 46 are provided at the respective outlet pipe 32 and outlet line 33a from the receiver 22. In addition to the outlet temperature sensors, a flow sensor 48 is also provided to feed flow rate information directly back to the controller 36 to enable more accurate control of the output temperature.

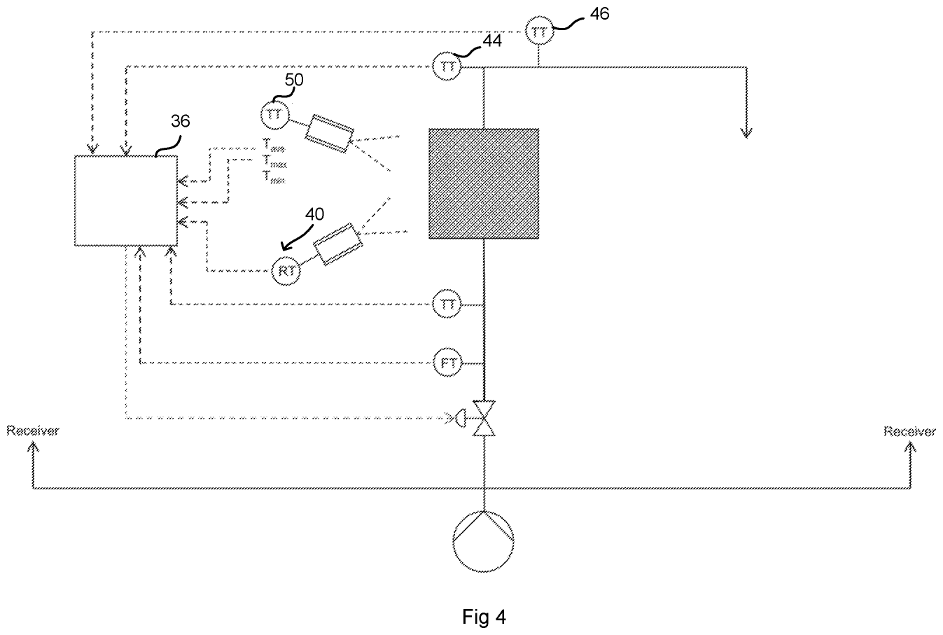

Referring now to FIG. 4, a further embodiment of the receiver control system is shown in which a surface temperature sensor 50 is used in conjunction with the radiation or flux measurement sensor 40. The surface temperature sensor may be in the form of one or more thermal imaging cameras or infrared sensors which are used to measure the surface temperature of the outer surface of the receiver 22 across the entire receiver. The temperature measurements may include the average temperature Tₐᵥ across the receiver, the maximum temperature Tₘₐₓ at any one or more points on the receiver as well as the minimum temperature Tₘᵢₙ. Signals representative of these values are then conveyed to the controller 36 to provide a further input for control purposes.

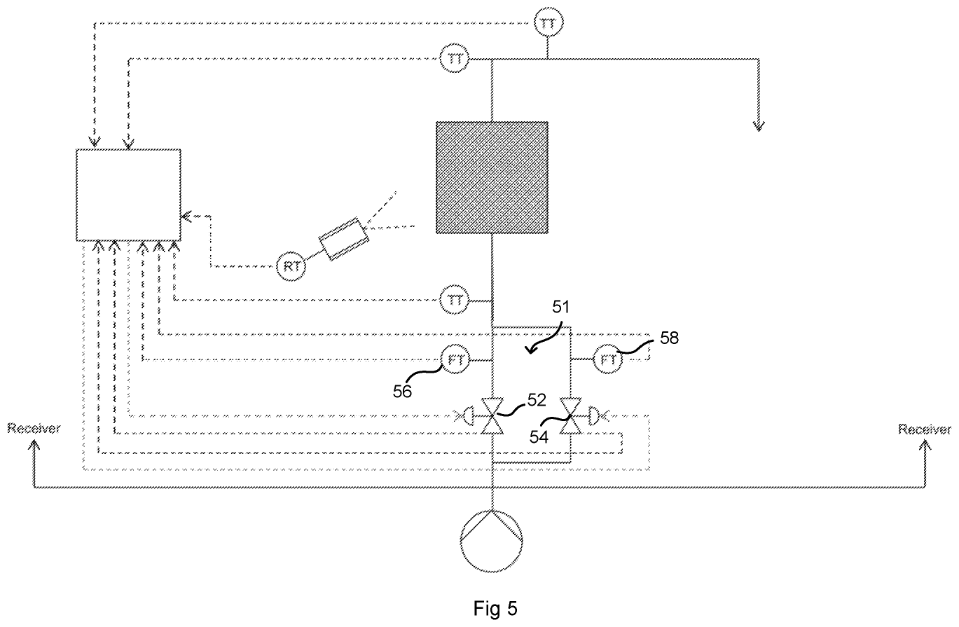

In FIG. 5, a further embodiment of the receiver control system is shown in which the valve arrangement includes a split valve assembly 51 having two flow valves 52, 54 configured in parallel with corresponding flow sensors 56 and 58. It will be appreciated that further valves could be added in parallel, and the valves may have the same maximum flow rates, or be disposed as one or more valves with higher and lower flow rates to suit the control system and intent of delivering in combination the higher turndown ratio. The split valve assembly enables the turn down ratio to be increased above a ratio of 5:1. This may include a ratio exceeding 8:1, 10:1, and 15:1, up to approximately 20:1. This allows flow control over a wide range, which in turn enables the flow to be varied from a minimum, which would occur in the case of partly overcast conditions, or during morning and evening, particularly in winter, to a maximum flow where the heat flux delivered to the receiver by the heliostat field reaches a maximum, which is in turn dependent on the irradiance of the sun and the position of the sun relative to the particular solar field.

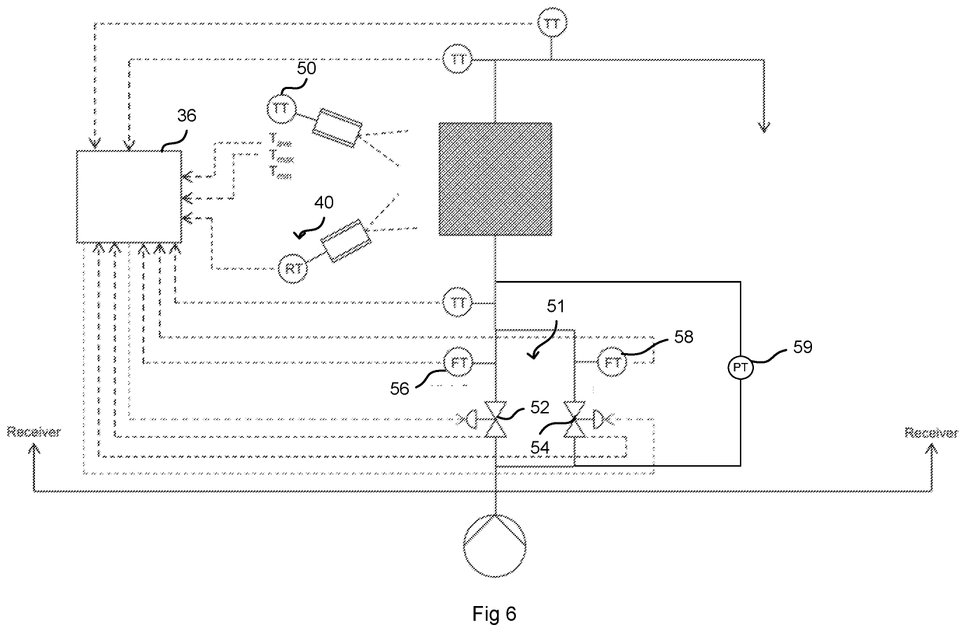

FIG. 6 shows a further embodiment in which, in addition to the split valve arrangement 51, the surface temperature sensor 40 is incorporated to provide variable temperature data to the controller 36. FIG. 6 also shows the option of an additional pressure sensor 59 measuring the pressure difference between the inlet and outlet of the flow control device 51. Use of the pressure sensor provides additional information for the characterisation of the flow behaviour of the valve or valves in the flow control device, and improves the controllability of the flow control device.

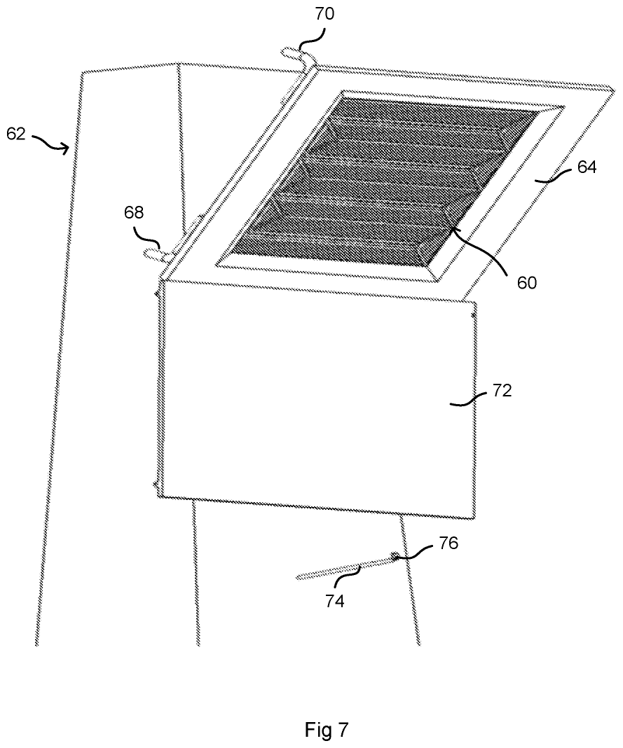

Referring now to FIG. 7, a billboard-type receiver 60 is shown mounted towards the top of a solar tower 62. The billboard receiver 60 includes a surround 64 and a serpentine tubular array 66 which is recessed relative to the surround, the tubular arraying including a fluid inlet pipe 68 and a fluid outlet pipe 70. A door 72 is hinged to the base of the surround for selectively closing the receiver. It will be appreciated that the door 72 may also be a top-hinged door of the type described and illustrated in PCT/AU2018/051220. A spar 74 carrying a pyranometer assembly 76 extends outwardly from the front portion of the tower directly below the receiver door 72.

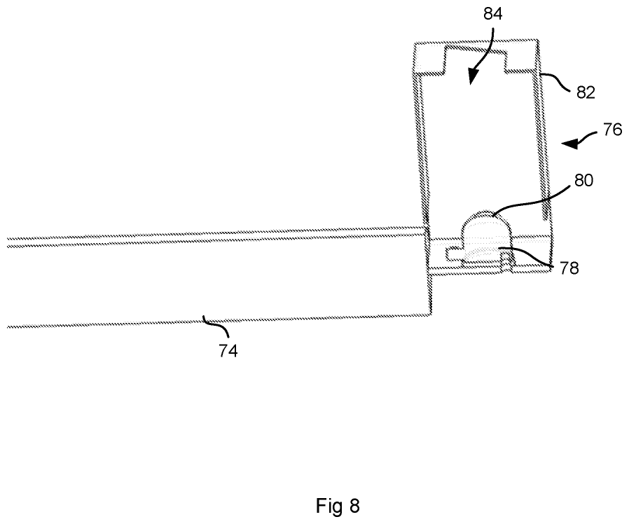

FIG. 8 shows a more detailed view of the pyranometer assembly 76 mounted to the end of the spar 74. The pyranometer assembly 76 includes a pyranometer, such as the aforementioned Apogee SP-510 pyranometer, having a top window 80 and mounted within a housing 82. An uppermost wall of the housing 82 is formed with a trapezoidal opening 84 which provides a mask configured to limit the radiation falling on the pyranometer window 80 to radiation from the receiver 22. Because of the oblique angle of the receiver relative to the pyranometer, the opening 84 is trapezoidal. In one non-limiting example where the mask is 92 mm away from the pyranometer sensor, the aperture is 54 mm wide at its longer side to view a 3.6 m edge of the receiver which is approximately 6.1 m away. The aperture is in turn 38 mm wide at its smallest side to view an upper 3.6 m edge of the receiver which is 8.8 m away, and is approximately 30 mm high to view the 3.6 m sides of the receiver, noting that they are foreshortened by a relatively acute viewing angle.

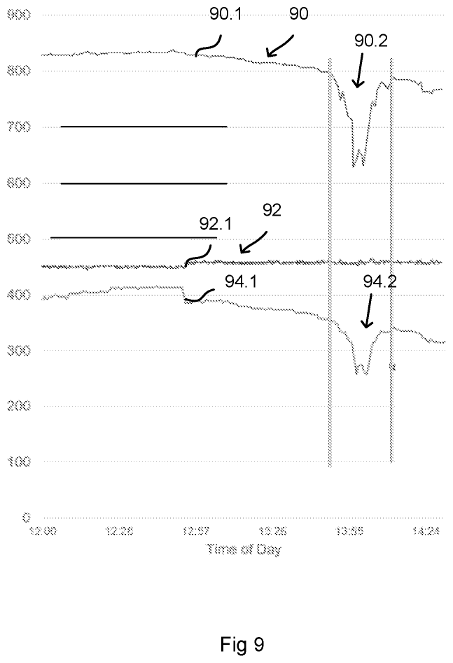

Referring now to FIG. 9, a graphical readout of output temperature of liquid sodium over time in response to variations in DNI and flow rate of sodium through the receiver is shown. The readout includes a measurement 90 of DNI in W/m² from noon until about 14 h30 taken from a pyrheliometer which was located in the region of the field and aimed directly at the sun to measure DNI for overall plant performance, without taking into account the aggregate influence of all the heliostat mirrors.

Also shown is a temperature output reading 92 from the set-point controller 36 as well as an output reading 94 of the flowrate of sodium through the receiver, as controlled by the valve arrangement 34 in response to control signals from the controller. The controller was responsive to the reading from the pyranometer measuring a value representing the aggregate radiation on the receiver, and not the pyrheliometer, which only gave a reading of direct beam solar irradiance at one point in the solar field.

After a period of relatively constant DNI as indicated by the pyrheliometer reading at 90.1, at around 12.50 the temperature set point was adjusted up from about 450 C where it had remained constant to 455 C. This almost immediately resulted in a stepwise decrease in the flowrate from about 4.15 l/s to 3.85 l/s, with the temperature stepping up at 92.1 and remaining constant at the upper level of 455 C. There was a gradual decrease in radiation up until 13 h40, and a corresponding decrease in the flow rate to maintain the temperature at the correct setpoint. At about 13 h40 clouds reduced the DNI significantly for about 30 mins, as is shown at 90.2. This resulted in a corresponding downward adjustment in flowrate 94.2 to keep the outlet temperature 92 at a constant level, with no perceptible undershoot or overshoot. During the entire period there was no heliostat defocussing.

In the particular example the liquid sodium at a medium flow rate of 4l/s would take about 10 s to transition through the receiver, with a typical slower flow rate corresponding to about 2.5 l/s taking 16 s to transition through the receiver. With the turn down controller operating at the lower end it could be turned down to 0.4 l/s which would represent a turn down ratio of about 15:1 in the case of a maximum flow rate of 6 l/s. As a result, the system is able to perform in highly variable conditions with patchy cloud cover during the early morning or late afternoon and during winter where for example the flow rate may need to be varied between 3 l/s and 0.4 l/s to maintain a constant output temperature. Conventionally the system is simply turned off during these highly variable low maximum periods where effective control of output temperature becomes increasingly difficult.

It will be appreciated that the dimensions and shape of the aperture window 84 will vary depending on the exact locations and relative locations of the pyranometer and the housing. For example, the pyranometer assembly may be located laterally on one or both sides of the receiver, with the aperture of the housing being appropriately shaped to capture the radiation from the receiver. It will further be appreciated that the pyranometer cannot be located directly in front of the receiver or anywhere which would correspond to or be close to the focal region of the heliostat array, resulting in the pyranometer being exposed to excessively high temperatures well in excess of its typical maximum operating temperature of 80 C. It will further be appreciated that the pyranometer will be used to obtain a measurement of the aggregate radiation on the receiver as opposed to the radiation on the individual heliostats, which even if aggregated will generally not represent the aggregate radiation on the receiver as this would be predicated on all of the heliostats being perfectly focussed on the receiver. In one embodiment, a pyranometer is located on either side of the receiver to provide two radiation measurement sources for greater accuracy and to allow for redundancy in case one of the pyranometers fails.

On occasions such as cloudless days in high summer, when a peak DNI (direct normal irradiance) is expected to be greater than can be handled at maximum flow rate, a certain number of heliostat mirrors would be defocussed. However this would not be done as a way of continuously controlling the radiation incident on the receiver, but rather to limit the total radiation due to environmental conditions.

It will be understood that the invention disclosed and defined in this specification extends to all alternative combinations of two or more of the individual features mentioned or evident from the text or drawings. All of these different combinations constitute various alternative aspects of the invention.

1. A concentrated solar energy collection system, comprising:
an array of heliostats;
a solar receiver including a plurality of tubes having at least one inlet and at least one outlet for carrying a heat transfer fluid, an external surface of the tubes receiving solar radiation reflected from the array of heliostats for heating the heat transfer fluid;
a flow control arrangement for controlling the flow of heat transfer fluid through the tubes;
at least one radiation sensor for sensing values representative of the aggregate solar radiation falling on the solar receiver via the heliostats;
at least one temperature sensor for measuring input temperature of the heat transfer fluid (HTF) at or near the inlet; and
a controller responsive to the at least one radiation sensor and the at least one temperature sensor for regulating the outlet temperature of the HTF by controlling the flow of HTF through the tubes via the flow control arrangement.

2. The concentrated solar energy collection system according to claim 1, further comprising a pressure differential sensor arrangement for measuring pressure differential across the flow control arrangement, the pressure differential sensor arrangement providing an input to the controller.

3. The concentrated solar energy collection system according to claim 1, wherein the at least one radiation sensor includes an actinometer spaced from the receiver and having a window configured to mask radiation not emanating from the receiver.

4. The concentrated solar energy collection system according to claim 3, wherein the actinometer includes a pyranometer, such as a thermopile pyranometer.

5. The concentrated solar energy collection system according to claim 1, wherein the flow control arrangement is in the form of a valve arrangement and associated valve control elements having an overall turn down ratio greater than 5:1

6. The concentrated solar energy collection system according to claim 5, wherein the valve arrangement and associated valve control elements have a turn down ratio of at least 10:1.

7. The concentrated solar energy collection system according to claim 5, wherein the valve arrangement and associated valve control elements have a turn down ratio of at least 12:1.

8. The concentrated solar energy collection system according to claim 6, wherein the valve arrangement and associated valve control elements have a turn down ratio of at least 15:1.

9. The concentrated solar energy collection system according to claim 5, wherein the valve arrangement includes at least two valves in parallel.

10. The concentrated solar energy collection system according to claim 1, wherein during normal operation the outlet temperature of the HTF is solely controlled by the valve arrangement.

11. The concentrated solar energy collection system according to claim 1, wherein the HTF is a liquid metal, either as a pure element or in a eutectic mixture with other elements.

12. The concentrated solar energy collection system according to claim 11, wherein the HTF is selected from a group comprising liquid sodium, eutectic mixtures of sodium and potassium (NaK), eutectic mixtures of lead and bismuth (PbBi), and tin.

13. The concentrated solar energy collection system according to claim 1, wherein the controller includes feedforward control elements.

14. The concentrated solar energy collection system according to claim 1, further comprising a flow sensor for measuring the inflow of HTF into the receiver, the flow sensor providing an input to the controller.

15. The concentrated solar energy collection system according to claim 1, further comprising at least one temperature sensor for measuring the outlet temperature of the HTF, the temperature sensor providing an input to the controller.

16. The concentrated solar energy collection system according to claim 1, further comprising at least one thermal imaging camera or sensor for providing data associated with a thermal image of an outer face of the receiver to the controller.

17. The concentrated solar energy collection system of claim 1, wherein the concentrated solar energy collection system is one of a plurality of solar energy collection systems coupled to an HTF reservoir, a pump for recirculating HTF through the systems, and a heat exchanger for extracting heat from the HTF using a second HTF which is preferably salt, wherein the salt is used as a heat source to drive one or more steam turbines.

18. A method of operating a concentrated solar energy collection system, comprising:
an array of heliostats;
a solar receiver including a plurality of tubes having at least one inlet and at least one outlet for carrying a heat transfer fluid (HTF), an external surface of the tubes receiving solar radiation reflected from the heliostats for heating the HTF; and
a flow control arrangement for controlling the flow of HTF through the tubes;
the method including:
sensing values representative of the aggregate solar radiation falling on the solar receiver via the heliostats using at least one radiation sensor;
measuring the input temperature of the HTF at or near the inlet using at least one temperature sensor; and
responsive to the radiation sensor and input temperature, regulating the outlet temperature of the HTF by controlling the flow of HTF through the tubes via the flow control arrangement.

19. The method according to claim 18, further comprising measuring pressure differential across the flow control arrangement using a pressure differential sensor arrangement, the pressure differential sensor arrangement providing an input to which the controller is responsive.

20. A method according to claim 19 further comprising measuring the inflow of HTF into the receiver using a flow sensor, the flow sensor providing an input to which the controller is responsive, measuring the outlet temperature of the HTF using a temperature sensor, the temperature sensor providing an input to which the controller is responsive, and providing data associated with a thermal image of an outer face of the receiver to the controller as an input to which the controller is responsive using at least one thermal imaging camera or sensor;
wherein during normal operation, the outlet temperature of the HTF is solely controlled by the flow control arrangement via the controller; and
wherein the flow control arrangement is in the form of a valve arrangement including at least one valve and associated valve control elements and control of the outlet temperature of the HTF is achieved by controlling the flow of HTF through the valve arrangement between maximum and minimum flows corresponding to turn down ratios selected from a group including greater than 5:1, at least 10:1, at least 12:1 or at least 15:1.

21-24. (canceled)
